(19) United States
(12) Patent Application Publication
(10) Pub. No.: US 2018/0205209 A1
(43) Pub. Date: Jul. 19, 2018

(54) WIRE HOUSING PROTECTOR

(71) Applicant: Sumitomo Wiring Systems, Ltd., Yokkaichi, Mie (JP)

(72) Inventor: Ryo SUENAGA, Yokkaichi, Mie (JP)

(21) Appl. No.: 15/742,134

(22) PCT Filed: Aug. 20, 2015
(86) PCT No.: PCT/JP2015/073367

§ 371 Date: Jan. 5, 2018

(30) Foreign Application Priority Data
Jul. 6, 2015 (JP) 2015-135667

(51) Int. Cl. H02G 3/04; B60R 16/02

(52) U.S. Cl. CPC H02G 3/0437; H02G 3/0418; B60Y 2410/115; B60Y 2410/10; B60R 16/0215

(57) ABSTRACT

A locking mechanism includes an elastic projecting piece provided with an engagement protrusion at its leading end, and an elastic projecting piece insertion hole including an engagement portion that engages with the engagement protrusion. The elastic projecting piece is inserted into the elastic projecting piece insertion hole while the leading end of the elastic projecting piece is pressed toward a side opposite to a side to which the engagement protrusion protrudes, and then the elastic projecting piece elastically returns, whereby the engagement protrusion engages with the engagement portion, and the lid is held by the protector body. A collapsing rib that is located above and in the vicinity of the engagement portion is provided on a surface, of the elastic projecting piece insertion hole, in which the engagement portion is formed.

### CROSS REFERENCE TO RELATED APPLICATIONS

This application claims the priority of Japanese patent application JP2015-135667 filed on Jul. 6, 2015, the entire contents of which are incorporated herein.

### TECHNICAL FIELD

The present invention relates to a wire housing protector for holding multiple electric wires laid therethrough that are routed inside an automobile or the like.

### BACKGROUND ART

Conventionally, in the electric system of automobiles or the like, multiple routed electric wires are laid through and held within a wire housing protector and secured at suitable locations in order to protect the electric wires from external members that might otherwise interfere with the electric wires and restrict the routing of the electric wires.

Incidentally, as described in JP H06-70415U (Patent Document 1) for example, such a wire housing protector is constituted by a trough-shaped protector body and a lid that covers the upper opening of the protector body. Once multiple electric wires are laid through the protector body, the lid is fixed to the protector body by a locking mechanism that protrudes from a sidewall of the protector body. In this way, the protector is capable of holding the multiple electric wires accommodated therein.

However, wire housing protectors having the foregoing conventional structure have an inherent problem in that, because the locking mechanism protrudes outward from a sidewall of the protector body, some of the capacity of the wire housing portion of the protector body is sacrificed so as to secure space for the locking mechanism. Especially in recent years, the demand for downsizing automobiles has been growing while the quantity of on-vehicle electrical equipment has also been increasing. Accordingly, there is a need to increase the housing space inside the protector body without enlarging the space necessary for mounting the wire housing protector. At times, conventionally structured wire housing protectors have been unable to meet this requirement sufficiently. In particular, there have been cases in which the lid could not easily interlock with the protector body because there were too many electric wires for the capacity of the wire housing protector.

Therefore, the applicant proposed, in JP 2014-82880A (Patent Document 2), a wire housing protector including a locking mechanism that is constituted by an elastic projecting piece that projects from an outer peripheral edge of a lid toward a protector body and an elastic projecting piece insertion hole that passes through the inside of a side wall of the protector body and opens in an upper surface, and in which an engagement protrusion provided at a leading end of the elastic projecting piece that has been inserted into the inside of the elastic projecting piece insertion hole engages with an engagement portion that projects from an inner surface of the elastic projecting piece insertion hole so as to prevent the lid from separating from the protector body. According to such a wire housing protector, because the locking mechanism is provided inside the side wall of the protector body, the side wall of the protector body can be extended to a maximum range of the space that is allowed to mount the wire housing protector, compared with a conventional structure in which the locking mechanism protrudes outward from the side wall of the protector body. Therefore, a dead space around the protector body that occurs due to the locking mechanism that protrudes outward from the side wall can be reduced, and the wire accommodating space in the protector body can be increased.

However, in such a structure in which the locking mechanism is provided inside the side wall of the protector body, after the elastic projecting piece has been inserted into the elastic projecting piece insertion hole, the engagement protrusion formed at the leading end of the elastic projecting piece engages with the engagement portion formed inside the elastic projecting piece insertion hole, and as a result, it is difficult to visually confirm the state of engagement between the engagement protrusion and the engagement portion from the outside. Moreover, since the locking mechanism is provided inside the side wall of the protector body, the size of protrusions of the engagement protrusion and the engagement portion in a plate thickness direction of the elastic projecting piece need to be small, and as a result, the displacement amount of the elastic projecting piece when the engagement protrusion is fitted to the engagement portion becomes small, and there is an inherent problem in that a worker cannot easily sense the engagement between the engagement protrusion and the engagement portion.

### SUMMARY

The present design has been made in view of the above-described circumstances and, as a solution to the problem, provides a wire housing protector having a new structure in which the volume of electric wires that can be accommodated can be increased by downsizing the locking mechanism, and whether members in the locking mechanism are engaged properly can be more easily confirmed.

A first aspect of the design provides a wire housing protector including: a protector body extending in the shape of a trough; a lid for covering an upper opening of the protector body; and a locking mechanism for fixedly holding the protector body and the lid. The locking mechanism includes: an elastic projecting piece that protrudes from the lid and is provided with an engagement protrusion at its leading end; and an elastic projecting piece insertion hole that passes through the inside of a side wall of the protector body and opens in an upper surface of the side wall, and includes an engagement portion that engages with the engagement protrusion. The elastic projecting piece can be inserted into the elastic projecting piece insertion hole while the leading end of the elastic projecting piece is pressed toward a side opposite to a side to which the engagement protrusion protrudes, and when the elastic projecting piece elastically returns, the engagement protrusion engages with the engagement portion and the lid is held by the protector body. A collapsing rib that is located above and in the vicinity of the engagement portion is provided on a surface, of the elastic projecting piece insertion hole, at which the engagement portion is formed.

According to the present aspect, because the locking mechanism is provided inside the side wall of the protector body and is designed to have a small size, the side wall of the protector body can be extended to a maximum range of the space that is allowed to mount the wire housing protector, compared with a conventional structure in which the locking mechanism protrudes outward from the side wall of the protector body, and the wire accommodating space in the protector body can be increased. In addition, the collapsing rib that is located above and in the vicinity of the engagement portion is provided in the elastic projecting piece insertion hole. When the elastic projecting piece is inserted into the elastic projecting piece insertion hole at the time of the lid being assembled to the protector body, first, the engagement protrusion approaches the engagement portion with receiving a constant sliding resistance relative to the surface at which the engagement portion of the engagement protrusion is formed, and the sliding resistance increases due to the collapsing rib immediately before the engagement protrusion engages with the engagement portion. Therefore, an assembly worker can easily and securely confirm that members in the locking mechanism have been properly fitted together by the change in resistance such that the sliding resistance rapidly increases when the engagement protrusion comes into contact with the collapsing rib, and then the sliding resistance decreases after the elastic projecting piece undergoes elastic restoration. Therefore, although the locking mechanism is provided inside the side wall of the protector body and is structured such that the state of engagement between the engagement protrusion and the engagement portion cannot be visually confirmed from the outside, the volume of electric wires that can be accommodated can be increased and the ability to confirm whether members in the locking mechanism are engaged properly can be improved.

A second aspect of the design provides the wire housing protector according to the first aspect, wherein a lower end surface of the collapsing rib is continuous to an upper end surface of the engagement portion.

According to the present embodiment, since the collapsing rib is provided immediately above the engagement portion so as to be continuous thereto, the increase in sliding resistance due to the collapsing rib and the elastic restoration of the elastic projecting piece can be caused to occur successively. Accordingly, the worker can more clearly sense the drop in sliding resistance, and can more easily confirm whether the engagement protrusion and the engagement portion are properly engaged.

A third aspect of the design provides the wire housing protector according to the first aspect, wherein the lower end surface of the collapsing rib is contiguous with the upper end surface of the engagement portion, flush with the upper end surface, and constitutes a flat extending surface that extends straight toward the elastic projecting piece.

According to the present embodiment, since the flat extending surface that extends from the upper end surface of the engagement portion toward the elastic projecting piece and flush therewith is constituted by the lower end surface of the collapsing rib, the area of contact between the engagement portion and the engagement protrusion increases. Accordingly, as a result of providing the collapsing rib, not only the ability to confirm whether the engagement protrusion engages with the engagement portion is improved, but also a further effect in that the retaining force of the locking mechanism increases can be achieved.

A fourth aspect of the design provides the wire housing protector according to the first or second aspect, wherein the collapsing rib protrudes in a semicircular cross-sectional shape.

According to the present embodiment, since the collapsing rib protrudes in a semicircular cross-sectional shape, the engagement protrusion smoothly slides over the collapsing rib, and an excessive increase in force that needs to be applied when the elastic projecting piece is inserted can be advantageously avoided.

A fifth aspect of the design provides the wire housing protector according to any one of the first to fourth aspects, wherein an opposing surface of the elastic projecting piece that opposes the collapsing rib is provided with a recess with which the collapsing rib engages.

According to the present embodiment, a recess with which the collapsing rib engages is provided in the opposing surface of the elastic projecting piece that opposes the collapsing rib. The engagement protrusion slides over the collapsing rib and the elastic projecting piece undergoes elastic restoration, in addition, the collapsing rib engages with the recess, that is, the collapsing rib is housed in the recess. Accordingly, a click feeling when the collapsing rib engages with the recess can be given in addition to a larger change in sliding resistance due to further reduction in the sliding resistance, and as a result, whether members in the locking mechanism are properly fitted together can be further easily and securely confirmed. Moreover, the retaining force of the locking mechanism can be exerted using the engagement of the collapsing rib with the recess.

According to the wire housing protector of the present design, because the locking mechanism is provided inside the side wall of the protector body and is designed to have a small size, the side wall of the protector body can be extended to a maximum range of the space that is allowed to mount the wire housing protector, compared with a conventional structure in which the locking mechanism protrudes outward from the side wall of the protector body, and the wire accommodating space in the protector body can be increased. In addition, the collapsing rib that is located above and in the vicinity of the engagement portion is provided on the surface, of the elastic projecting piece insertion hole, at which the engagement portion is formed. When the lid is assembled to the protector body, an assembly worker can easily and securely confirm that members in the locking mechanism have been properly fitted together by the change in resistance such that the sliding resistance rapidly increases when the engagement protrusion comes into contact with the collapsing rib, and then the sliding resistance decreases after the elastic projecting piece undergoes elastic restoration. Therefore, although the locking mechanism is provided inside the side wall of the protector body and is structured such that the state of engagement between the engagement protrusion and the engagement portion cannot be visually confirmed from the outside, the volume of electric wires that can be accommodated can be increased and the ability to confirm whether members in the locking mechanism are properly fitted together can be improved.

### BRIEF DESCRIPTION OF DRAWINGS

FIG. 1 is a general perspective view of a wire housing protector according to a first embodiment.

FIG. 2 is an exploded perspective view of the wire housing protector of the present embodiment.

FIG. 3 is a plan view of the wire housing protector of the present embodiment.

FIG. 4 is an enlarged cross-sectional view taken along line IV-IV in FIG. 3.

FIG. 5 is a cross-sectional view illustrating a wire housing protector according to a second embodiment, which corresponds to FIG. 4.

FIG. 6 is a cross-sectional view illustrating a wire housing protector according to a third embodiment, which corresponds to FIG. 4.

FIG. 7 is a cross-sectional view illustrating a wire housing protector according to a fourth embodiment, which corresponds to FIG. 4.

### DESCRIPTION OF EMBODIMENTS

Hereinafter, embodiments of the present design will be described with reference to the drawings.

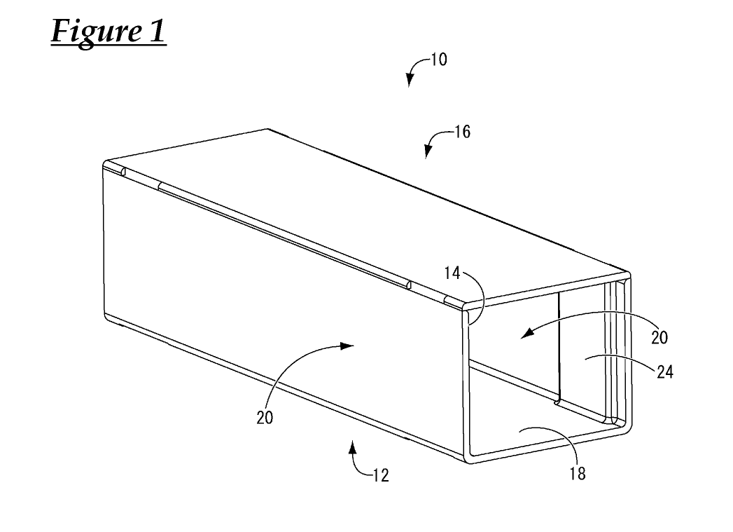

First, a wire housing protector 10 according to a first embodiment is shown in FIGS. 1 to 4. The wire housing protector 10 is constituted by a protector body 12 extending in the shape of a trough and a lid 16 that covers the upper opening 14 of the protector body 12. When in use, the wire housing protector 10 accommodates a wire harness (not shown) laid through the protector body 12. Also, in the following description, “upward” refers to the upward direction in FIG. 1, “downward” refers to the downward direction in FIG. 1, “forward” refers to the leftward direction in FIG. 1, and “backward” refers to the rightward direction in FIG. 1.

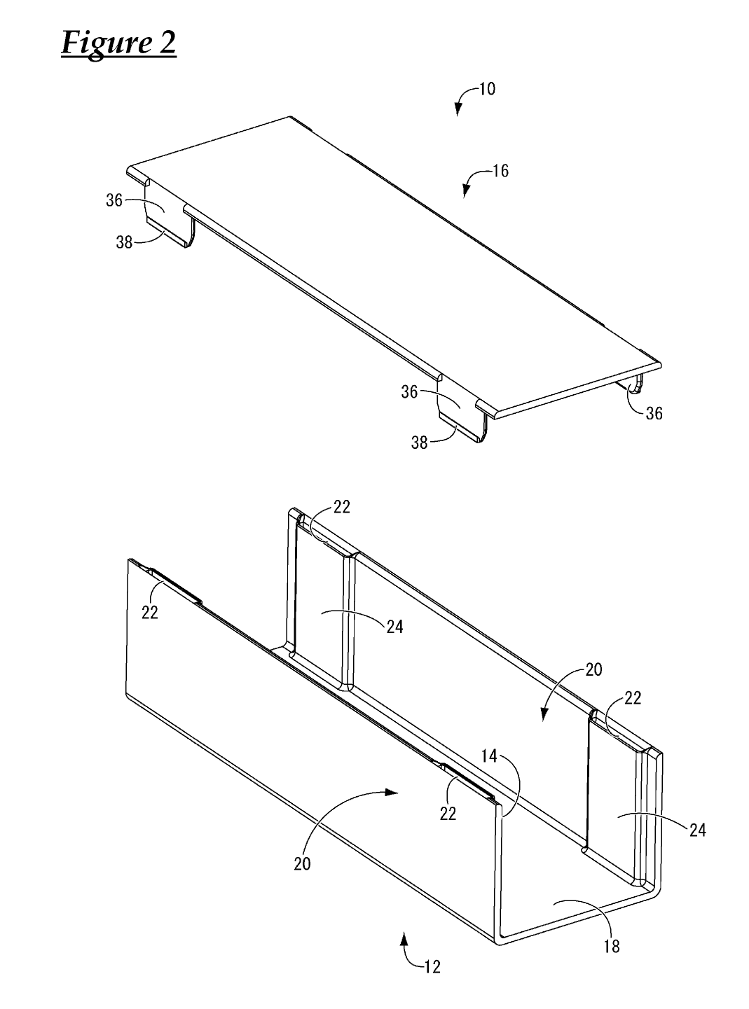

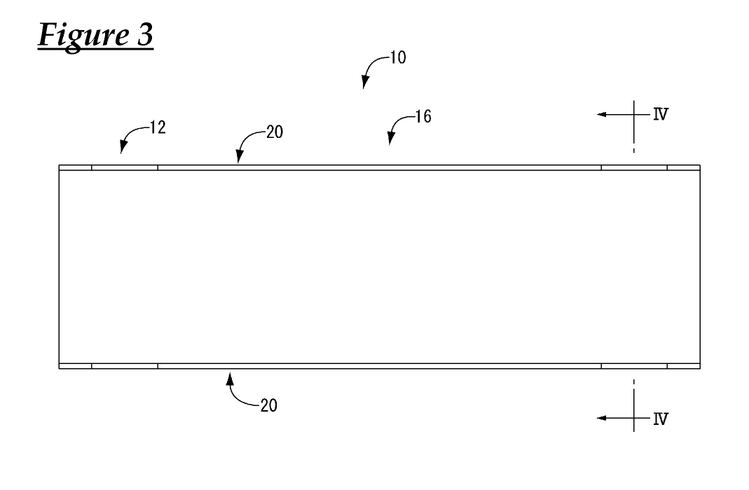

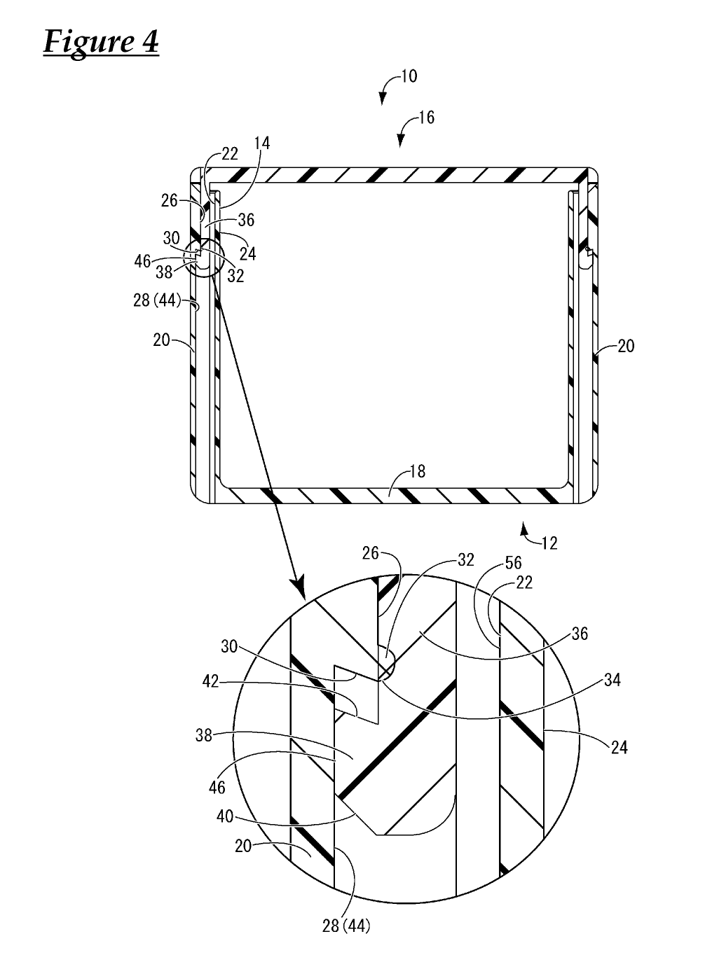

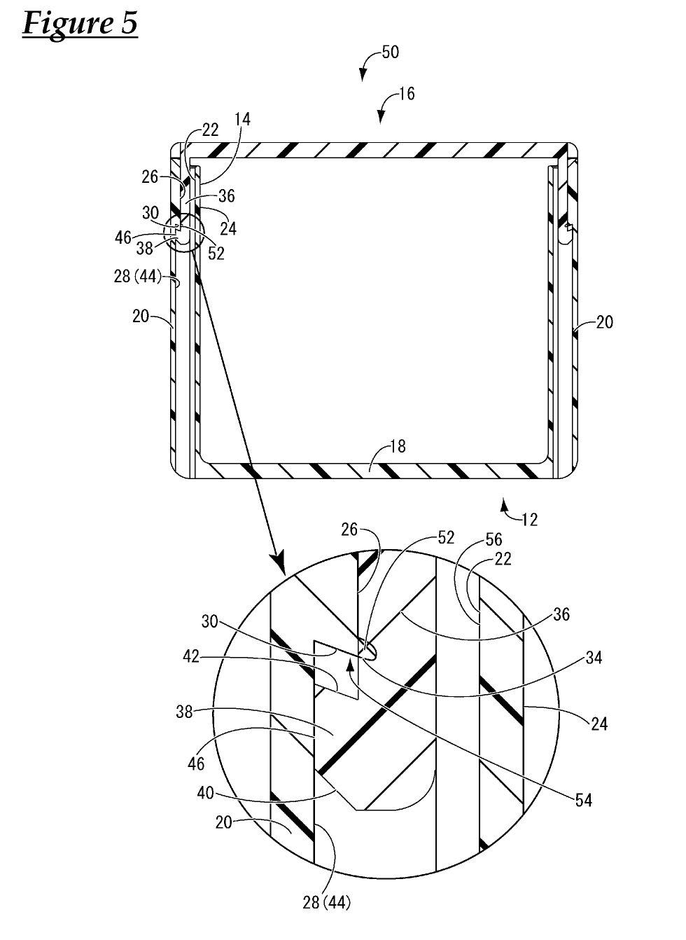

As shown in FIG. 2, the protector body 12 is configured to extend in the shape of a trough, includes a bottom wall 18 and a pair of sidewalls 20 rising upright from the both sides of the bottom wall 18, and is integrally formed of synthetic resin such as polypropylene (PP) or polyamide (PA), for example, by injection molding or the like. Also, in the side wall 20 of the protector body 12, elastic projecting piece insertion holes 22 that pass through the inside of the side wall 20 in a height direction and open in an upper surface of the side wall 20 are provided. In the present embodiment, two elastic projecting piece insertion holes 22 are formed in each of a back side and a front side of the side wall 20, but any number of elastic projecting piece insertion holes 22 that are separated in a longitudinal direction (left-right direction in FIG. 2) may be provided as necessary. Here, an inner surface 24 of the side wall 20 where the elastic projecting piece insertion holes 22 are formed slightly protrudes toward the inside of the protector body 12. Furthermore, as shown in FIG. 4, an engagement portion 28 having a substantially recessed shape, which is formed by cutting out a portion, on a lower side, of an inner side 26 of the outer wall of the elastic projecting piece insertion hole 22, is provided in the elastic projecting piece insertion hole 22. An upper end surface 30 of the engagement portion 28 is a sloping surface that slopes obliquely downward toward the inside of the protector body 12. In addition, a collapsing rib 32 is provided at a lower end of the inner side 26 of the outer wall at which the engagement portion 28 is formed in the elastic projecting piece insertion hole 22. The collapsing rib 32 is located in the vicinity of the upper end surface 30 of the engagement portion 28, projects toward the inside of the protector body 12, has an approximately semicircular cross-sectional shape, and extends in a width direction (left-right direction in FIG. 3) of the elastic projecting piece insertion hole 22. Furthermore, a lower end surface 34 of the collapsing rib 32 is continuous to the upper end surface 30 of the engagement portion 28. Note that to facilitate understanding, in FIG. 4 and later-described FIG. 5, the collapsing rib 32 is depicted in a state in which it is not deformed by the contact between the inner side 26 of the outer wall and a later-described elastic projecting piece 36.

Meanwhile, as shown in FIG. 2, the lid 16 is provided with, at its outer edge, a plurality of elastic projecting pieces 36 that each have a substantially rectangular shape, project toward the protector body 12, and are flexible in a plate thickness direction. Also, an engagement protrusion 38 that protrudes outward in a plate thickness direction is provided on an outer surface at a leading end of the elastic projecting pieces 36. Furthermore, as shown in FIG. 4, a lower end surface 40 of the engagement protrusion 38 is a tapered surface that gradually slopes outward from its lower end toward its upper end in a direction in which the protector body 12 and the lid 16 are assembled. An upper end surface 42 of the engagement protrusion 38 is a sloping surface that slopes obliquely downward toward the inside of the protector body 12, similarly to the upper end surface 30 of the engagement portion 28 of the elastic projecting piece insertion hole 22. Note that, in the present embodiment, four elastic projecting pieces 36 are formed in correspondence with the elastic projecting piece insertion holes 22 described above. Also, the lid 16 is, similarly to the protector body 12, integrally formed of synthetic resin such as polypropylene (PP) or polyamide (PA), for example, by injection molding or the like, but is formed separately from the protector body 12.

The plurality of elastic projecting pieces 36 of the lid 16 are inserted into the respectively corresponding plurality of elastic projecting piece insertion holes 22 of the protector body 12, the engagement portions 28 of the elastic projecting piece insertion holes 22 are respectively engaged with the engagement protrusions 38 of the elastic projecting pieces 36, and as a result, the lid 16 is fixedly held by the protector body 12, as shown in FIGS. 1 and 4. In this way, in the present embodiment, the locking mechanism is constituted by the engagement portions 28 of the elastic projecting piece insertion holes 22 and the engagement protrusions 38 of the elastic projecting pieces 36.

Next, with reference to FIG. 4, the locking mechanism will be described in detail. First, the leading end of the elastic projecting piece 36 of the lid 16 is inserted into the elastic projecting piece insertion hole 22. Because the lower end surface 40 of the engagement protrusion 38 of the elastic projecting piece 36 is a tapered surface, as a result of pushing the leading end of the elastic projecting piece 36 of the lid 16 in a direction toward the protector body 12, the leading end of the elastic projecting piece 36 is inserted into the elastic projecting piece insertion hole 22 while the leading end is pressed toward the inner surface 24 side of the protector body 12, that is, toward a side opposite to the side to which the engagement protrusion 38 protrudes, due to an action of the tapered surface. The engagement portion 28 that is formed by cutting out the lower side of the inner side 26 of the outer wall and has a substantially recessed shape is provided in the elastic projecting piece insertion hole 22. The collapsing rib 32 is located in the vicinity of the upper end surface 30 of the engagement portion 28, at a lower end of the remaining inner side 26 of the outer wall. Therefore, when the elastic projecting piece 36 is pushed even deeper into the elastic projecting piece insertion hole 22, and the engagement protrusion 38 provided in the leading end of the elastic projecting piece 36 passes over the collapsing rib 32 and reaches the engagement portion 28, the elastic projecting piece 36 undergoes elastic restoration, and the engagement protrusion 38 comes into contact with a bottom surface 44 of the engagement portion 28. Accordingly, the engagement protrusion 38 of the elastic projecting piece 36 engages with the engagement portion 28 of the elastic projecting piece insertion hole 22, and the lid 16 is fixedly held by the protector body 12. In this engagement state, the upper end surface 42 of the engagement protrusion 38 of the elastic projecting piece 36 and the upper end surface 30 of the engagement portion 28 of the elastic projecting piece insertion hole 22 are arranged so as to face each other in the direction in which the protector body 12 and the lid 16 are assembled, and are sloping surfaces that extend obliquely downward toward the inside of the protector body 12 approximately parallel to each other.

According to the wire housing protector 10 of the present embodiment having such a structure, because the engagement protrusion 38 of the elastic projecting piece 36 engages with the engagement portion 28 of the elastic projecting piece insertion hole 22 inside the elastic projecting piece insertion hole 22 provided in the side wall 20 of the protector body 12, the side wall 20 of the protector body 12 can be extended to a maximum range of the space that is allowed to mount the wire housing protector 10, compared with a conventional structure in which such an engagement has been performed by the locking mechanism that protrudes outward from the side wall 20 of the protector body 12. In addition, the engagement portion 28 that is formed by cutting out the lower side of the inner side 26 of the outer wall of the elastic projecting piece insertion hole 22 and has a substantially recessed shape is provided, and a collapsing rib 32 that is located in the vicinity of the upper end surface 30 of the engagement portion 28 is provided at a lower end of the remaining inner side 26 of the outer wall. Accordingly, when the lid 16 is assembled to the protector body 12, first, a projecting end surface 46 of the engagement protrusion 38 of the elastic projecting piece 36 is pressed toward the inner side 26 of the outer wall of the elastic projecting piece insertion hole 22, and as a result, the elastic projecting piece 36 is inserted into the elastic projecting piece insertion hole 22 while receiving an approximately constant sliding resistance. When the elastic projecting piece 36 is further inserted deep into the elastic projecting piece insertion hole 22 and the projecting end surface 46 of the engagement protrusion 38 slides over the collapsing rib 32, the sliding resistance rapidly increases. Then, after the engagement protrusion 38 has slid over the collapsing rib 32 and the elastic projecting piece 36, it undergoes elastic restoration, and the sliding resistance decreases. Accordingly, an assembling worker can easily and securely confirm that members in the locking mechanism have been properly fitted together by the change in resistance such that the sliding resistance rapidly increases when the engagement protrusion 38 slides over the collapsing rib 32, and then the sliding resistance decreases after the elastic projecting piece 36 undergoes elastic restoration. That is, even in a case where whether members in the locking mechanism are properly fitted together cannot be visually confirmed from the outside, as in the present embodiment, whether members in the locking mechanism are properly fitted together can be easily and securely confirmed by such a change in resistance.

Also, the lower end surface 34 of the collapsing rib 32 is continuous to the upper end surface 30 of the engagement portion 28, that is, the collapsing rib 32 is provided directly above the engagement portion 28 and is continuous thereto, and therefore, the increase in sliding resistance when the engagement protrusion 38 slides over the collapsing rib 32 and the decrease in the sliding resistance when the elastic projecting piece 36 undergoes elastic restoration can be caused to occur successively. As a result of the worker clearly feeling a large change in sliding resistance in this way, the worker can further easily confirm whether the members of the locking mechanism have been properly fitted together. Furthermore, since the collapsing rib 32 has a semicircular cross-sectional shape, the engagement protrusion 38 can smoothly slide over the collapsing rib 32, and an excessive increase in sliding resistance due to the collapsing rib 32 can be advantageously avoided.

Next, a wire housing protector 50 according to a second embodiment of the present design will be described in detail with reference to FIG. 5. Members and portions having a structure similar to those in the above embodiment will be denoted in this diagram by the same reference signs as in the above embodiment, thereby omitting detailed descriptions for them. The wire housing protector 50 according to the second embodiment is different from the wire housing protector 10 according to the first embodiment in that the collapsing rib 52 has an approximately quarter circular cross-sectional shape, and the lower end surface 34 of the collapsing rib 52 is contiguous with the upper end surface 30 of the engagement portion 28 and flush therewith and constitutes a flat extending surface 54 that extends straight toward the elastic projecting piece 36.

According to the present embodiment, since the flat extending surface 54 that extends toward the elastic projecting piece 36 side from the upper end surface 30 of the engagement portion 28 and flush therewith is formed by the lower end surface 34 of the collapsing rib 32, the size of the upper end surface 30 of the engagement portion 28 that comes into contact with the upper end surface 42 of the engagement protrusion 38 can be increased when an upward force is applied such that the elastic projecting piece 36 of the lid 16 separates from the elastic projecting piece insertion hole 22 of the protector body 12. Accordingly, the retaining force of the locking mechanism can be further increased.

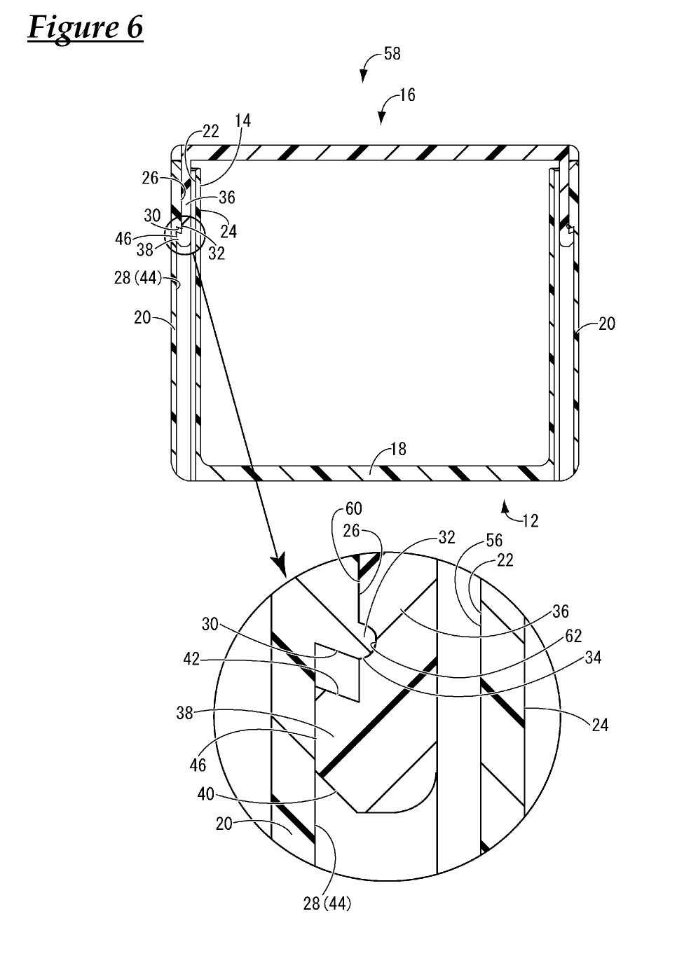

Next, a wire housing protector 58 according to a third embodiment of the present design will be described in detail with reference to FIG. 6. Members and portions having a structure similar to those in the above embodiment will be denoted in this diagram by the same reference signs as in the above embodiment, thereby omitting detailed descriptions for them. The wire housing protector 58 according to the third embodiment is different from the wire housing protector 10 according to the first embodiment in that a recess 62 having a recessed groove shape is provided at an opposing surface 60 of the elastic projecting piece 36 that opposes the collapsing rib 32. The recess 62 opens in the opposing surface 60, and extends in a width direction (left-right direction in FIG. 3) of the elastic projecting piece 36, and the collapsing rib 32 engages with the recess 62.

According to the present embodiment, the recess 62 with which the collapsing rib 32 engages is provided at the opposing surface 60, of the elastic projecting piece 36, that opposes the collapsing rib 32. The engagement protrusion 38 slides over the collapsing rib 32 and the elastic projecting piece 36 undergoes elastic restoration, and in addition, the collapsing rib 32 engages with, that is, is accommodated in the recess 62. Accordingly, an even larger change in sliding resistance can be realized and a click feeling when the collapsing rib 32 engages with the recess 62 can be sensed, and as a result, whether members in the locking mechanism are properly fitted together can be further easily and securely confirmed.

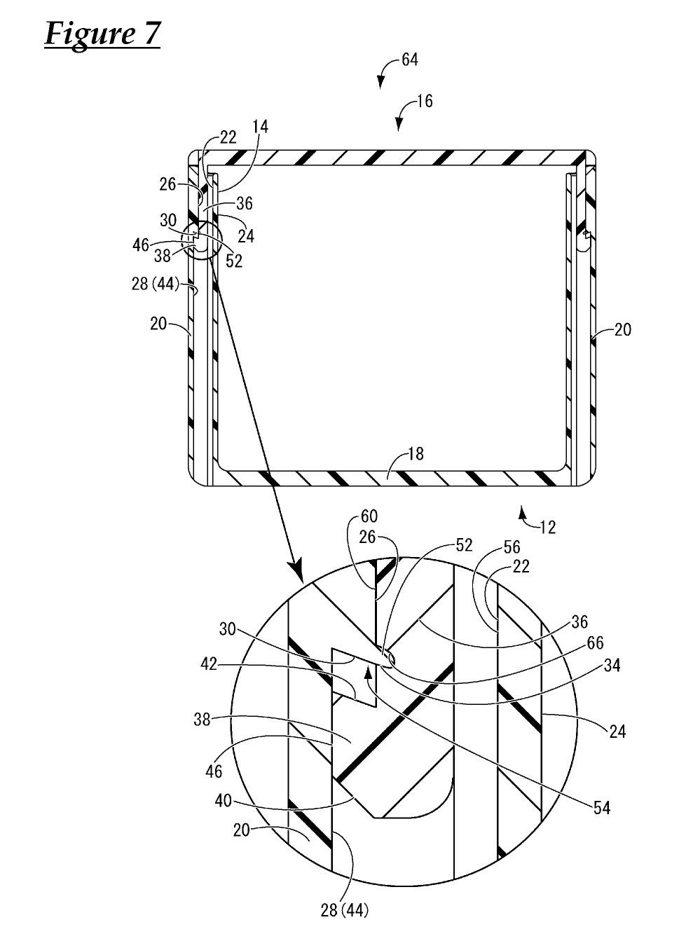

A wire housing protector 64 according to a fourth embodiment of the present design is illustrated in FIG. 7. The wire housing protector 64 according to the fourth embodiment is different from the wire housing protector 50 according to the second embodiment in that a recess 66 having a recessed groove shape is provided at the opposing surface 60 of the elastic projecting piece 36 that opposes the collapsing rib 52. The recess 66 opens in the opposing surface 60, and extends in the width direction (left-right direction in FIG. 3) of the elastic projecting piece 36, and the collapsing rib 52 engages with the recess 66. In the present embodiment as well, a large change in sliding resistance can be obtained and a click feeling can be sensed when the collapsing rib 52 engages with, that is, is accommodated in the recess 66, and an effect in that whether members in the locking mechanism are properly fitted together can be further easily and securely confirmed can be obtained, similarly to the third embodiment described above. Note that, in the third and fourth embodiments, the retaining force of the locking mechanism can be increased as well as a result of the collapsing rib 32 or 52 engaging with the recesses 62 or 66.

Although embodiments of the present design have been described in detail above, the present invention is not limited by these specific descriptions. For example, although the collapsing ribs 32 and 52 respectively have an approximately semicircular cross-sectional shape and an approximately quarter circular cross-sectional shape in the embodiments described above, any cross-sectional shape such as triangular cross-sectional shape or rectangular cross-sectional shape can be adopted. Also, the engagement protrusion 38 may be provided on the inner surface of the leading end of the elastic projecting piece 36, and the engagement portion 28 may be provided at the inner peripheral side inner surface 56 of the elastic projecting piece insertion hole 22.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

### LIST OF REFERENCE NUMERALS

10, 50, 58, 64: Wire housing protector
12: Protector body
14: Upper opening
16: Lid
20: Side wall
22: Elastic projecting piece insertion hole (locking mechanism)
26: Outer peripheral side inner surface (surface at which engagement portion is formed)
28: Engagement portion
30: Upper end surface
32, 52: Collapsing rib
34: Lower end surface
36: Elastic projecting piece (locking mechanism)
38: Engagement protrusion
54: Flat extending surface
60: Opposing surface
62, 66: Recess

1. A wire housing protector comprising:
a protector body extending in the shape of a trough;
a lid for covering an upper opening of the protector body; and
a locking mechanism for fixedly holding the protector body and the lid,
wherein the locking mechanism includes:
an elastic projecting piece that protrudes from the lid and is provided with an engagement protrusion at its leading end; and
an elastic projecting piece insertion hole that passes through the inside of a side wall of the protector body and opens in an upper surface of the side wall, and includes an engagement portion that engages with the engagement protrusion,
wherein the wire housing protector is configured such that the elastic projecting piece can be inserted into the elastic projecting piece insertion hole while the leading end of the elastic projecting piece is pressed toward a side opposite to a side to which the engagement protrusion protrudes, and when the elastic projecting piece elastically returns, the engagement protrusion engages with the engagement portion and the lid is held by the protector body,
wherein a collapsing rib that is located above and in the vicinity of the engagement portion is provided on that surface of the elastic projecting piece insertion hole, in which the engagement portion is formed.

2. The wire housing protector according to claim 1, wherein a lower end surface of the collapsing rib is continuous to an upper end surface of the engagement portion.

3. The wire housing protector according to claim 2, wherein the lower end surface of the collapsing rib is contiguous with the upper end surface of the engagement portion, flush with the upper end surface, and constitutes a flat extending surface that extends straight toward the elastic projecting piece.

4. The wire housing protector according to claim 1, wherein the collapsing rib protrudes in a semicircular cross-sectional shape.

5. The wire housing protector according to claim 1, wherein an opposing surface of the elastic projecting piece that opposes the collapsing rib is provided with a recess with which the collapsing rib engages.
